(19) United States
(12) Patent Application Publication
(10) Pub. No.: US 2005/0276577 A1
(43) Pub. Date: Dec. 15, 2005

(54) Recording medium, image recording apparatus, image recording method, and image recording program

(75) Inventors: Akira Yoda, Kanagawa-ken (JP); Shuji Ono, Kanagawa-ken (JP); Yukita Gotohda, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minamiashigara-Shi (JP)

(21) Appl. No.: 11/106,676

(22) Filed: Apr. 15, 2005

(30) Foreign Application Priority Data
Apr. 15, 2004 (JP) 2004-120222

(51) Int. Cl. H04N 5/76; H04N 5/781

(52) U.S. Cl. 386/95; 386/125

(57) ABSTRACT

Various kinds of information including information such as image data can be recorded in a recording medium without substantially lowering production efficiency. A DVD-R storing image data, meta-data of the image data, and DVD-Video files has a dual layer structure comprising a first recording layer and a second recording layer. The first recording layer comprises an organic dye layer and the second recording layer has a phase-change alloy layer. The image data are recorded in the first recording layer while the meta-data and the DVD-Video files that can be generated again are recorded in the second recording layer.

### BACKGROUND OF THE INVENTION

1. Filed of the Invention

The present invention relates to a recording medium such as a DVD-R for recording various kinds of information including image data, and to an image recording apparatus and an image recording method for recording image data in a recording medium. The present invention also relates to a program for causing a computer to execute the image recording method.

2. Description of the Related Art

Prints generated from conventional silver-salt photographic films have been used in various manners. For example, such prints and films are used for checking how images look, for communication with friends by showing the prints, for sending additional prints to friends, for display of enlargements thereof, and for generating photo albums. However, prints generated from silver-salt photographic films only accumulate if the prints are not set in order. Therefore, using the prints and the films, such as finding a desired one of the prints and generating an additional print, becomes difficult. Especially, in the case where the number of prints becomes large, the prints tend to be left without consideration of photography order, which makes setting the prints in order more difficult.

Prints can be used easily if arranged in order frequently. However, classification of prints according to time and date of photography or theme is troublesome. Even if prints are set in order in the form of a photo album, no copy of the photo album is usually made. Therefore, enjoying photographs therein is difficult for a large number of people or for a person-living in a remote-place.

If classification of prints is neglected, not only prints but also negative films accumulate. Negative films are in most cases left as they are or stored in bags or boxes without classification thereof. If a user as a photographer ages and the number of family members increases, the number of prints and negative films also increases more and more. Therefore, a large amount of prints and negative films are neglected if no classification is carried out thereon. Prints and negative films are seldom discarded since no additional prints can be made if they are discarded. Consequently, many households are troubled by how to classify and store such prints and films.

Meanwhile, a photograph service system has been proposed in Japanese Unexamined Patent Publications No. 10(1998)-150538 or 10(1998)-150541, for example. In such a system, images recorded on a negative film or prints are read by a reading apparatus such as a scanner for obtaining image data sets. The image data sets are stored in a recording medium such as a CD-R and reproduced by a reproduction apparatus such as a personal computer for appreciation thereof. Furthermore, the image data sets are printed at the request of a user. In addition, a network photograph service system including an image storage system has also been proposed in Japanese Unexamined Patent Publication No. 11(1999)-154218, for example. In the network photograph service system, image data sets are sent to and stored in an image storage server via a network such as the Internet, and various kinds of processing regarding the image data sets, such as viewing the image data sets and placing a printing order, can be carried out with use of a terminal remote from the image storage server.

However, in the image storage system described above, images are read from a negative film at the same time as the images are printed after development of the film. Therefore, image data sets are stored collectively for each roll of film. Consequently, relating a user who requested storage of the image data sets to the film roll is a troublesome task. In addition, images are only read from a negative film and stored thereafter. Therefore, a large amount of image data sets are simply stored without being set in order if images are read from prints or negative films neglected in a household. In this case, a user who accesses the image storage server needs to set the image data sets in order, which is as troublesome as in the case of classification of the prints and the negative films. Therefore, such a system is not convenient.

For this reason, a so-called “photo mining” service system has been proposed in U.S. patent No. 20030151767, for example. In this system, image data sets are obtained from recording media such as prints and negative films, and related to recording media information representing the recording media from which the image data sets have been obtained. The image data sets related to the recording media information are then stored for each user, based on user information. In this system, if a user only requests image reading from a DPE store although a large amount of prints and negative films neglected in his/her household have not been set in order, the user can view image data sets obtained through the image reading in a state wherein the image data sets are classified according to the recording media information.

By using the system described in U.S. patent No. 20030151767, image data obtained by reading can be provided to a user by being recorded in a recording medium such as a DVD-R. At this time, image data in the form of a slide show can be generated from the image data obtained by reading, and can be recorded in the recording medium together with the original image data. In this manner, the user can enjoy the slide show by using his/her DVD player and can appreciate the image data by using his/her terminal such as a personal computer.

The image data read from the recording media in the above manner need to be recorded in a recording medium of high durability, since the image data are irrecoverable if destroyed. However, time necessary for writing the image data in a high-durability recording medium is long. Consequently, in the photo mining service for recording the image data and the image data of the slide show in a recording medium, production efficiency becomes lower if a high-durability recording medium is used.

### SUMMARY OF THE INVENTION

The present invention has been conceived based on consideration of the above circumstances. An object of the present invention is therefore to enable recording of various information including important information such as image data in a recording medium without substantially lowering production efficiency.

A recording medium of the present invention is a recording medium for recording various kinds of information including image data. The recording medium has a first recording area and a second recording area, and is characterized by that the first recording area has higher durability than the second recording area.

In the recording medium of the present invention, the first recording area may be not rewritable while the second recording area may be rewritable.

The recording medium of the present invention may form a dual layer structure. In this case, the layer on the topside may be the second recording area when viewed from a reading unit.

The recording medium of the present invention may be shaped into a disc. In this case, the first recording area may be located on the inner peripheral side thereof while the second recording area may be located on the outer peripheral side thereof.

The recording medium of the present invention may have still image data sets recorded in the first recording area and image data recorded in the second recording area in the form of a slide show for reproducing the still image data sets in predetermined order, as well as meta-data recorded in both the first and second recording areas for describing a manner of reproduction of the slide show.

An image recording apparatus of the present invention comprises recording means for recording still image data sets, image data, and meta-data in a recording medium comprising a first recording area and a second recording area. The first recording area has higher durability than the second recording area. The recording means records the still image data sets in the first recording area and records the image data in the second recording area in the form of a slide show for reproducing the still image data sets in predetermined order. The recording means also records the meta-data describing a manner of reproduction of the slide show in both the first and second recording areas.

In the image recording apparatus of the present invention, the first recording area may be not rewritable while the second recording area may be rewritable.

In the image recording apparatus of the present invention, the recording medium may form a dual layer structure. In this case, the layer on the topside may be the second recording area when viewed from a reading unit.

In the image recording apparatus of the present invention, the recording medium may be shaped into a disc. In this case, the first recording area may be located on the inner peripheral side thereof while the second recording area may be located on the outer peripheral side thereof.

An image recording method of the present invention comprises the steps of:

recording still image data sets in a first recording area in a recording medium comprising the first recording area having higher durability than a second recording area and the second recording area;

recording image data in the second recording area in the form of a slide show for reproducing the still image data sets in predetermined order; and

recording meta-data describing a manner of reproduction of the slide show in both the first and second recording areas.

The image recording method of the present invention may be provided as a program for causing a computer to execute the image recording method.

The recording medium of the present invention has the first recording area and the second recording area, and the first recording area has higher durability than the second recording area. In a recording medium, time necessary for data writing becomes longer as durability thereof becomes higher. Therefore, important information such as image data is recorded in the first recording area having the higher durability although writing the information becomes time-consuming. Information that can be reproduced from the image data, such as image data in the form of a slide show generated from the image data, is recorded in the second recording area whose durability is lower, which shortens the time necessary for writing. In this manner, production efficiency can be improved regarding the recording medium while the important information can be protected.

### BRIEF DESCRIPTION OF THE DRAWINGS

FIG. 1 is a block diagram showing the configuration of a photo mining system adopting a recording medium of an embodiment of the present invention;

FIG. 2 is a block diagram showing the configuration of an image generation apparatus;

FIG. 3 shows how meta-data are described;

FIG. 4 shows a file structure of image data and DVD-Video files recorded in a DVD-R (part 1);

FIG. 5 is a cross-sectional view of a structure of the DVD-R used in this embodiment;

FIG. 6 shows how data are written in a first recording layer and a second recording layer;

FIG. 7 is a cross-sectional view of a structure of the DVD-R used in this embodiment (part 2);

FIG. 8 shows how images are reproduced serially without an orientation change and with a change to portrait orientation;

FIG. 9 shows a link between DVD-Video files;

FIG. 10 shows how information is added to the meta-data;

FIG. 11 shows a change of compression rate according to value;

FIG. 12 shows different reproduction time according to value in one of the DVD-Video files;

FIG. 13 shows lenticular image generation processing from three images;

FIG. 14 shows a state wherein narrow strips of an image are laid out next to narrow strips of another image along a longitudinal direction thereof, in the lenticular image generation processing; and

FIG. 15 is a block diagram showing an example the configuration of a DVD generation unit.

### DESCRIPTION OF THE PREFERRED EMBODIMENT

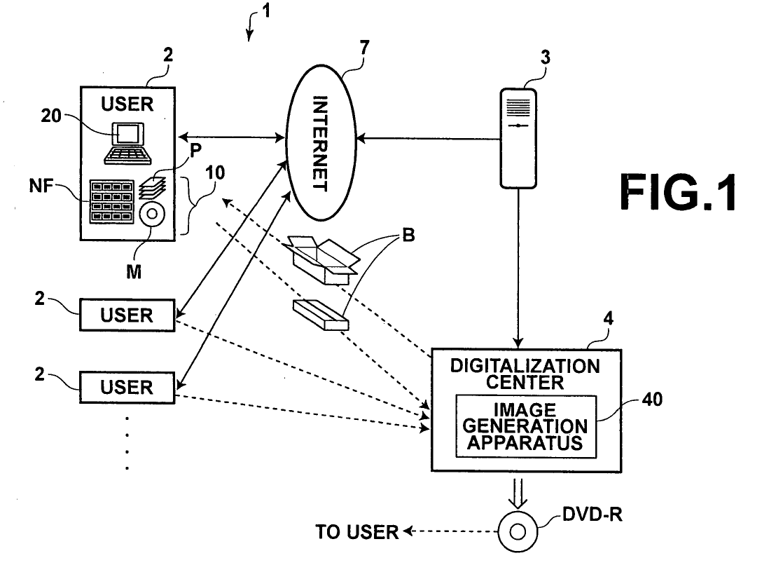

Hereinafter, an embodiment of the present invention will be described with reference to the accompanying drawings. FIG. 1 shows the configuration of a photo mining system adopting a recording medium of an embodiment of the present invention. As shown in FIG. 1, in a photo mining system 1, various kinds of information, negative films, prints, and the like are exchanged between users 2, a photo mining server 3 (hereinafter referred to as the PM server 3) that receives an order for a photo mining service placed by any one of the users 2 (hereinafter referred to as the user 2) via the Internet, and a digitalization center 4 that deals with the order.

In the photo mining service in this embodiment, image data sets S0 are obtained from negative films NF, prints P, and recording media M such as a CD-R and a memory card owned by the user 2. The image data sets S0 are recorded in a recording medium such as a DVD-R (in this embodiment, the recording medium is a DVD-R) together with DVD-Video files enabling slide shows generated from the image data sets S0. The DVD-R is then provided to the user 2.

The user 2 owns the negative films NF and the prints P without classification thereof, and stores a large amount of image data sets in the recording media M. The user 2 places the order for the photo mining service from the PM server 3 regarding the large amount of the negative films NF, the prints P, and the recording media M. More specifically, the user 2 has a user terminal 20 such as a personal computer connected to the Internet 7, and accesses the PM server 3 by using the user terminal 20 for placing the order.

The photo mining system 1 in this embodiment are for members only, and the user 2 has registered himself/herself with the PM server 3 to obtain a user ID and a password for identification. At the time of membership registration, the user 2 registers user information comprising items such as the name, the address, age, the phone number, the e-mail address, and family composition thereof. The user information is stored in the PM server 3 and in a user information database in the digitalization center 4 as will be described later.

The PM server 3 has a Web site for receiving the order for the photo mining service placed by the user 2. The user 2 accesses the Web site of the PM server 3 by using the user terminal 20, and inputs the user ID and the password for placing the order. The PM server 3 issues an order number upon reception of the order, and sends to the user 2 an e-mail message that notifies the user 2 of the order number and date of delivery, for confirmation of order reception. The PM server 3 sends notification of reception of the order to the digitalization center 4, and the notification includes the user information, the order number, date of delivery, and date of order reception.

When the notification of order reception is received from the PM server 3, an operator in the digitalization center 4 sends a delivery box B to the address of the user 2 with reference to the user information included in the notification and the user information database stored in the digitalization center 4 so that the user 2 can send the negative films NF, the prints P, and the recording media M (hereinafter collectively referred to as recording media 10) owned by the user 2 to the digitalization center 4. An order form recorded with the order number and the like of the user 2 is also sent to the user 2, together with the delivery box B. The order form is also pasted on the delivery box B. A bar code corresponding to the order number is printed on the order form. The delivery box B may be sent by a company other than the digitalization center 4.

When the user 2 receives the delivery box B, the user 2 encloses the recording media 10 of his/her own in the delivery box B, and sends the delivery box B to the digitalization center 4. At this time, the user 2 describes the type and quantity of the recording media 10, a comment, and the like on the order form, and sends the order form to the digitalization center 4.

When the delivery box B is received, the digitalization center 4 carries out processing for the photo mining service by using an image generation apparatus 40.

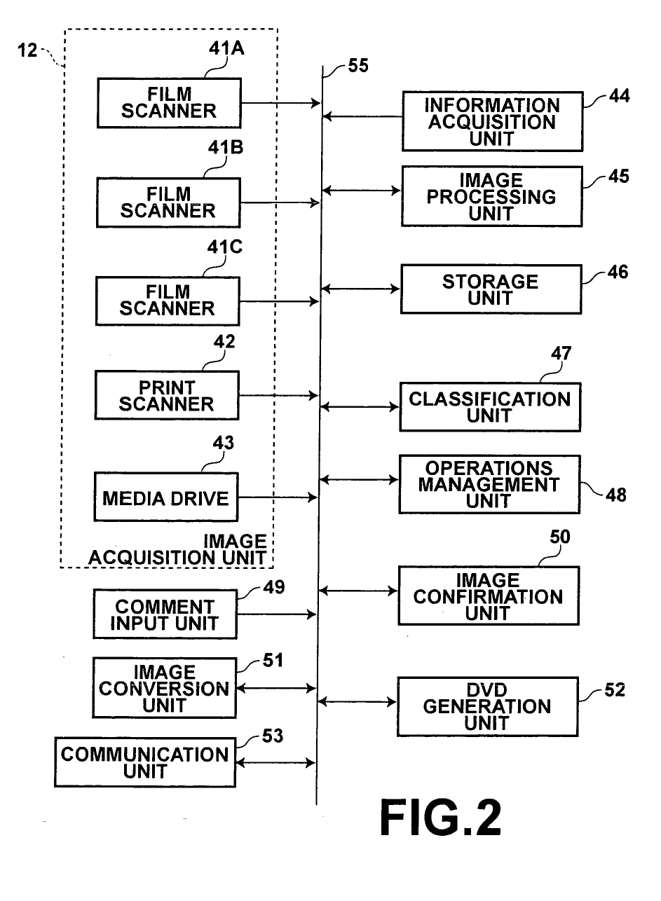

FIG. 2 is a block diagram showing the configuration of the image generation apparatus 40. The image generation apparatus 40 obtains the image data sets S0 from the recording media 10, and generates the DVD-R recorded with the image data sets. As shown in FIG. 2, the image generation apparatus 40 comprises film scanners 41A˜41C for obtaining the image data sets S0 by reading images recorded on the negative films NF, a print scanner 42 for obtaining the image data sets S0 by reading images recorded on the prints P, a media drive 43 for obtaining the image data sets S0 by reading the image data sets S0 from the recording media M, an information acquisition unit 44 that obtains information on date of photography (hereinafter referred to as the photography date information D) from the negative films NF and the prints P and from the image data sets S0 read from the recording media M and obtains various kinds of information to be added to the image data sets S0, an image processing unit 45 for obtaining processed image data sets S1 by carrying out image processing and image restoration processing such as red-eye correction processing on the image data sets S0, and a storage unit 46 for storing various kinds of information including the image data sets S1.

The image generation apparatus 40 further comprises a classification unit 47 for assigning any one of the film scanners 41A˜41C, the print scanner 42, or the media drive 43 (hereinafter collectively referred to as an image acquisition unit 12) to obtain the image data sets S0 from the recording media 10 sent by the user 2, an operations management unit 48 for managing the type of the image acquisition unit 12 used for obtaining the image data sets S0 from the recording media 10 for each of processes of acquisition (hereinafter referred to as a job), a comment input unit 49 for receiving input of a comment on the images for each of the jobs or for each of the images, an image confirmation unit 50 for confirming and correcting the images represented by the processed image data sets S1, an image conversion unit 51 for converting the image data sets 1 into image data sets S2 of Exif format by adding various kinds of information such as the comment to the image data sets S1, a DVD generation unit 52 for generating DVD-Video files V0 in the form of slide shows from the image data sets S2 and for generating the DVD-R recorded with the image data sets S2 and the DVD-Video files V0, and a communication unit 53 for communicating with the PM server 3.

The components in the image generation apparatus 40 are connected by a bus 55.

Each of the film scanners 41A˜41C sequentially reads the images recorded on the negative films NF, and obtains the image data sets S0 representing the images.

The print scanner 42 obtains the image data sets S0 representing the images on the prints P by reading the prints P.

The media drive 43 obtains the image data sets S0 by reading the image data sets S0 from the recording media M. Since the type of the recording media M varies, the media drive 43 of the type corresponding to the recording media M available on the market is used.

The information acquisition unit 44 obtains the photography date information D from the negative films NF, the prints P, and the like. Each of the negative films NF is recorded with a code number specific thereto (hereinafter referred to as a DX code). By referring to the DX code, a year range in which the film was produced can be inferred. Therefore, the information acquisition unit 44 reads the DX code recorded on each of the negative films NF, and obtains the photography date information D representing the year range of production of the corresponding negative film NF by referring to a year range database stored in the storage unit 46.

In the case where the negative films NF include so-called APS films each having a magnetic coating for recording magnetic information, the date of photography can be recorded in the magnetic coating as magnetic information. In this case, the photography date information D can be obtained by reading the magnetic information representing the date of photography recorded in the magnetic coating thereof.

In the case where the date is printed in each of the images, the date is read and character recognition is carried out thereon for obtaining the photography date. In this case, information obtained by reading the date printed in each of the images can be used as the photography date information D. In some cases, the date is hard to read, depending on the images. In such a case, the photography date information D of each of the images whose photography date was not readable may be obtained based on the date of photography readable from the images arranged immediately before and after the image in a sequence of image reading.

For the prints P, the date of photography is known by reading the date printed in each of the prints P and by carrying out character recognition thereon if the date is printed on each of the prints P. In this case, information obtained by reading the date in each of the prints P can be used as the photography date information D.

In the case where some of the prints P have a white margin, information representing the year range in which the corresponding prints P were printed, such as “Fujicolor 99”, may be present therein. Furthermore, the information representing the year range (such as a brand mark varying according to year of production) may be printed on the backside of the prints P. In such a case, information obtained by reading the margin or the backside and carrying out character recognition thereon may be used as the photography date information D.

In some cases, the user 2 has written the date of photography on film storage sheets, a bag containing the sheets, and/or on the backside of the prints P. Furthermore, the user 2 may have written the date of photography on the order form for each of the recording media 10. In such a case, the comment input unit 49 or the like may receive input of the date from the operator in the digitalization center 4, and the date is used as the photography date information D.

For the image data sets S0 read from the recording media M, the photography date information is described in a tag of each of the image data sets S0. Therefore, the photography date information D is obtained based on the information described in the tag.

As has been described above, the photography date information D can be obtained from the various sources such as the DX code, the date printed in each of the images, the date specified by the user 2, the information recorded on the margin or backside of the prints P, and the information in the tag. Therefore, priority of the sources is preferably determined so that the photography date information D can be obtained according to the priority. At this time, it is preferable for the sources to be recognizable. Alternatively, the photography date information D may be obtained in relation to each of the sources available, without determination of the priority in advance.

In addition to the photography date information D, the information acquisition unit 44 obtains the various kinds of information such as a frame number in the case of reading the negative films NF, and the type of the recording media 10 (either the negative films NF, the prints P, or the recording media M) from which the image data sets S0 were obtained, and generates information including the photography date information D.

The photography date information D obtained by the information acquisition unit 44 may be obtained at the same time as acquisition of the image data sets S0 by the image acquisition unit 12. In this case, the information acquisition unit 44 is installed together with the image acquisition unit 12, and an operator of the image acquisition unit 12 operates the information acquisition unit 44.

The image processing unit 45 obtains the processed image data sets S1 by carrying out image processing for improving image quality such as gradation processing, color conversion processing, and sharpness processing on the image data sets S0.

The storage unit 46 comprises a large-capacity hard disc, and temporarily stores the processed image data sets S1 as well as the image data sets S0 obtained by the film scanners 41A˜41C, the print scanner 42, and the media drive 43. In addition, the storage unit 46 stores the user information database and the year range database representing a relationship between the DX code and the year range of production of the films and a relationship between the brand mark of the prints and the year range of use of the brand mark.

The information acquisition unit 44 reads the DX code recorded on each of the negative films NF, and can obtain the photography date information D representing the year range in which the corresponding negative film NF was produced, with reference to the year range database. The information acquisition unit 44 also reads the brand mark printed on the backside of each of the prints P, and can obtain the photography date information D representing the year range in which the brand mark was used, with reference to the year range database.

The classification unit 47 assigns which of the parts in the image acquisition unit 12 obtains the image data sets S0 for each of the recording media 10 according to an instruction input by an operator.

The operations management unit 48 manages processing for the photo mining service carried out by the digitalization center 4. More specifically, the operations management unit 48 manages the entire processing carried out in the photo mining service, such as order reception, delivery of the delivery box B, receipt of the delivery box B, classification, acquisition of the image data sets S0, image processing, comment input, image confirmation, image conversion, DVD generation, DVD delivery, and payment, for each order number for each of the users 2.

The comment input unit 49 receives input of the comment for each of the image data sets. The comment can be the name of an event described by the user 2 on the film storage sheets of the negative films NF or on the backside of the prints P or on the order form, for example.

The image confirmation unit 50 is used for confirmation and correction of the image data sets S1 having been subjected to the image processing.

The image conversion unit 51 converts the image data sets S1 having been subjected to the image confirmation into the image data sets S2 in Exif format by adding the information registered with an operations management database for each of the images as a tag to the corresponding image data sets S1. At this time, the image conversion unit 51 carries out the conversion into the image data sets S2 by rotating the image data sets S1 whose orientation needs to be changed. Furthermore, the image conversion unit 51 changes file names of the image data sets S2 into file names added with an ID specific to the DVD-R that stores the image data sets S2. For example, in the case where the original file name of one of the image data sets S2 is pm0001.jpg and the ID specific to the DVD-R is U001, the file name is changed from pm0001.jpg to pm0001_U001.jpg.

The image conversion unit 51 also generates meta-data sets X0 corresponding respectively to the image data sets S2. The meta-data sets X0 are in the form of XML files, and have file names corresponding to the image data sets S2. For example, in the case where one of the image data sets S2 has the file name pm0001_U001.jpg, the file name of the meta-data set X0 thereof is meta0001_U001.xml.

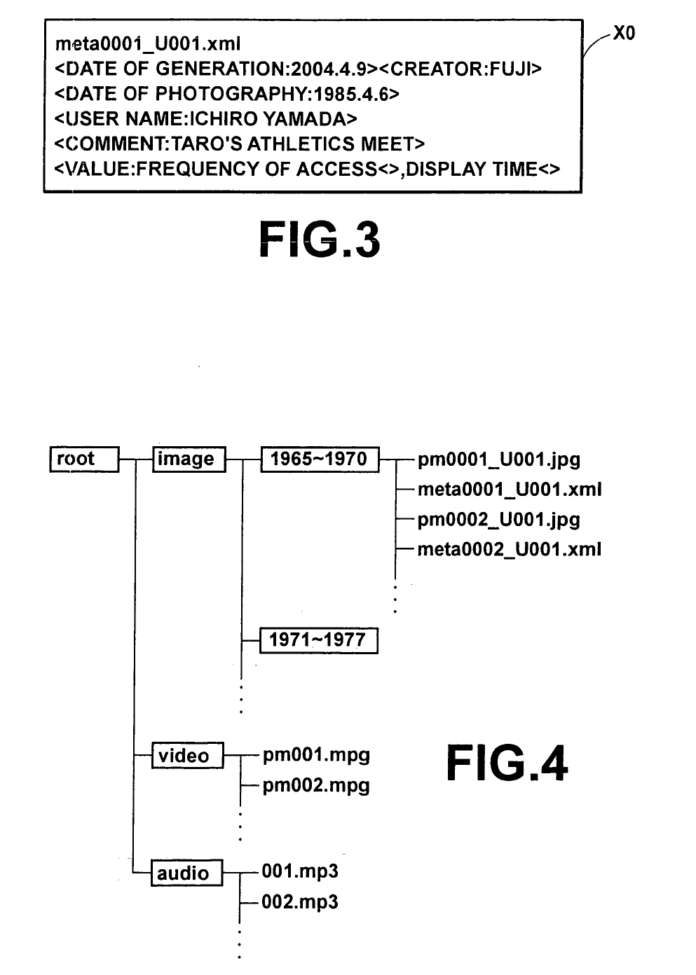

FIG. 3 shows how the meta-data sets X0 are described. As shown in FIG. 3, in each of the meta-data sets X0 are described the file name thereof, the date of generation of the corresponding image data set S2, the name of creator of the image data set S2 (in this case, the name of the photo mining service provider “FUJI” is described), the date of photography represented by the photography date information D, the name of the user having the corresponding recording medium 10 from which the image data set S2 has been obtained, the comment, and value of the image data set S2. The content of the value is added at each time the user 2 provided with the DVD-R recorded with the image data sets S2 uses the corresponding image data set S2. The file name of background music and an effect to be added at the time of slide show are added to each of the meta-data sets X0 whose corresponding image data set S2 is used for generation of the DVD-Video files V0 which will be described later.

The meta-data sets X0 for several images may be written collectively as a meta-data set X0 in one file. In this case, the meta-data set X0 describes the disc ID and the file names of the corresponding images, such as <disc ID; U001>, <file name; pm0001_U001.jpg>, <file name; pm0002_U001.jpg> and so on. The disc ID is an identifier specific to the DVD-R to be generated. In this case, the disc ID may be omitted in the file names, such as <disc ID; U001>, <file name; pm0001.jpg>, <file name; pm0002.jpg> and so on.

The DVD generation unit 52 records all the image data sets S2 and the meta-data sets X0 generated by the image conversion unit 51 in the DVD-R, and calculates total free space size in the DVD-R in the case where all the image data sets S2 are recorded in the DVD-R. The DVD generation unit 52 generates the DVD-Video files V0 whose size is appropriate for the free space size, and records the DVD-Video files V0 in the DVD-R.

More specifically, the image data sets S2 are classified into groups according to year range, and an appropriate number of the image data sets S2 are selected from each of the groups according to the free space size. MPEG format files enabling serial display of the selected image data sets S2 are then generated, and authoring is carried out through inclusion of a title menu and the background music. In this manner, the DVD-Video files V0 are generated.

Reproduction description files may be generated for representing reproduction order of the selected image data sets S2. In this case, the reproduction description files are recorded in a predetermined format in the DVD-R. The slide shows are reproduced by the reproduction order described in the reproduction description files by a player corresponding to the predetermined format. The predetermined format may be the MPV format in which the file names of the images to be reproduced and reproduction time therefor are described in the reproduction order in an MPV file. According to this format, the reproduction order can be easily changed, deleted, and added by simply editing the MPV file. In the case where the reproduction description files are generated, it is preferable for the images included in the DVD-Video files V0 to be selected at the time of generation of the reproduction description files.

It is also preferable for information (such as the file name) on a representative one of the images included in each of the slide shows to be recorded in relation to the corresponding reproduction description file. The information on the representative image is preferably described in the corresponding reproduction description file. In this case, the information on the representative image is represented by adding a mark to the file name of the representative image described in the reproduction description file. It is preferable for the mark to be added to more than one of the images.

As a method of selecting the representative images, a method of selection based on information on the value described in the meta-data sets may be adopted. Alternatively, a method of selection by dividing the images in each of the slide shows into several photography periods and by selecting the representative image from each of the periods may be adopted.

FIG. 4 shows a directory structure regarding the image data sets S2 and the DVD-Video files V0 recorded in the DVD-R. As shown in FIG. 4, the root directory contains “image” folder that stores the image data sets S2 and the meta-data sets X0, “video” folder that stores the DVD-Video files V0, and “audio” folder that stores music data sets used as the background music at the time of reproduction of the DVD-Video files V0.

Folders of the image data sets S2 according to year range are contained under the “image” folder, and store the image data sets S2 whose file names are pm0001_U001.jpg, pm0002_U001.jpg, and so on, and the meta-data sets X0 whose file names are meta0001_U001.xml, meta0002_U001.xml, and so on.

The meta-data sets X0 may be stored in correspondence with the respective images, as shown in FIG. 4. Alternatively, a meta-data set X0 may be generated and stored for each of the folders having been classified. In this case, the meta-data set X0 has additional information on the images stored in the corresponding folder, such as the file names, the date of photography, the value, a title, and the comment thereof. By storing the meta-data sets X0 for the respective folders, the images stored in the corresponding folders can be easily known with reference thereto. Furthermore, in this case, the meta-data sets X0 may have additional information regarding the image groups stored in the respective folders. The information on the image groups refers to information on the period of photography (the earliest photography date and the latest photography date) and the title of each of the image groups, and the file names of the representative images in the respective image groups, for example.

The “video” folder has the DVD-Video files V0 whose file names are pm001.mpg, pm002.mpg and so on. The video folder also stores MPEG data sets that have been obtained by a digital camera or a digital camcorder and recorded in the recording media M. It is also preferable for the video folder to store Index-Video files Vidx having file names such as pmIndex001.mpg and pmIndex002.mpg corresponding to the MPEG data sets and/or the DVD-Video files V0. The Index-Video files Vidx are generated by selecting only several representative frames from the corresponding original DVD-Video files such as pm001.mpg and pm002.mpg. The Index-Video files are displayed in a screen for selecting the DVD-Video files V0 to be reproduced by a DVD player or the like.

The “audio” folder contains the music data sets selectable by the user 2 as the background music used at the time of reproduction of the DVD-Video files V0. The “audio” folder has the music data sets whose file names are 001.mp3, 002.mp3, and so on.

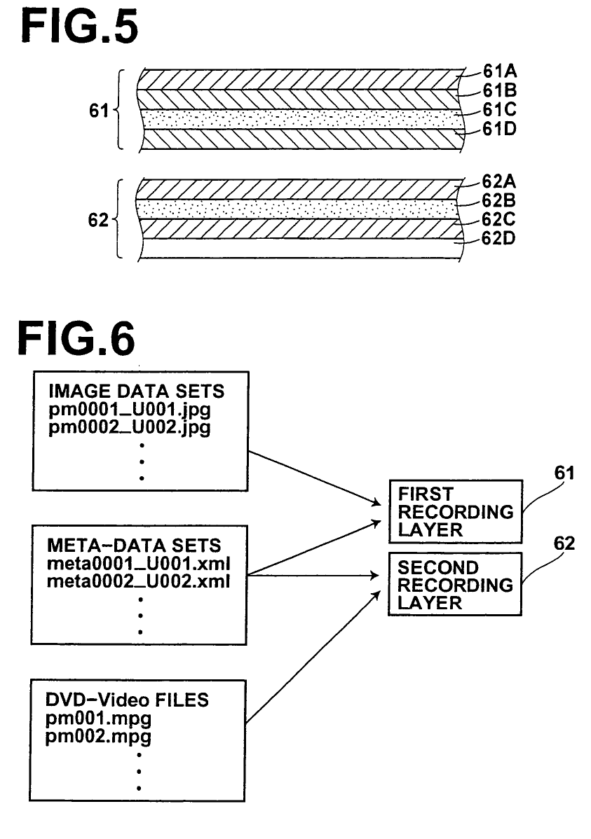

FIG. 5 is a diagram showing a structure of the DVD-R used in this embodiment. As shown in FIG. 5, the DVD-R used in this embodiment has two layers comprising a first recording layer 61 and a second recording layer 62. The first recording layer 61 comprises a protective layer 61A, a first SiO₂ layer 61B, an organic dye layer 61C, and a second SiO₂ layer 61D. Information is recorded in the first recording layer 61 by destruction of the organic dye layer with a leaser beam. The second recording layer 62 comprises a first SiO₂ layer 62A, a phase-change metal layer 62B, a second SiO₂ layer 62C, and a polycarbonate substrate 62D. Information in recorded in the second recording layer 62 by phase change in a crystal state of the phase-change metal layer 62B caused by heat of a laser beam. The second recording layer 62 is located on the side of reading and writing unit for the DVD-R.

The first recording layer 61 is located deeper than the second recording layer 62, which leads to lower probability of destruction. Therefore, data security is higher in the first recording layer 61 than the second recording layer 62. Furthermore, the organic dye layer 61C has higher durability than the phase-change metal layer 62B.

For this reason, in this embodiment, irrecoverable data such as the image data sets S2 obtained from the recording media 10 of the user 2 are recorded in the first recording layer 61 while data that can be generated again even after destruction thereof, such as the meta-data sets X0, the DVD-Video files V0, and the music data sets, are recorded in the second recording layer 62, as shown in FIG. 6. The second recording layer 62 may be a rewritable recording layer.

In the case where the meta-data sets X0 describe the manner of reproduction such as the reproduction order, the reproduction time, and the effect to be added at the time of reproduction of the slide shows, it is preferable for the meta-data sets X0 to be recorded in the first recording layer 61 and in the second recording layer 62 as shown in FIG. 6. In this manner, the DVD-Video files V0 stored in the second recording layer 62 can be restored from the image data sets S2 and the meta-data sets X0 stored in the first recording layer 61 having the higher durability even if the data cannot be read from the second recording layer 62 due to degradation thereof. In addition, correction such as changing the effect of the slide shows can be easily carried out by storing the meta-data sets X0 in the second recording layer 62 in addition to the first recording layer 61.

It is especially preferable for some of the image data sets S2 to be recorded in the first recording layer 61 in the case where the image data sets S2 are added with the meta-data sets X0 or having more items written in the meta-data sets X0 or having the information on the value of high evaluation written in the meta-data sets X0. By determining where the meta-data sets X0 are stored based on presence or absence of the meta-data sets X0, on the number of the items therein, and on a level of the value, the data of importance can be efficiently and securely stored even in the case where the capacity of the first recording layer 61 is limited or in the case where a total size of the image data sets S2 to be recorded is large.

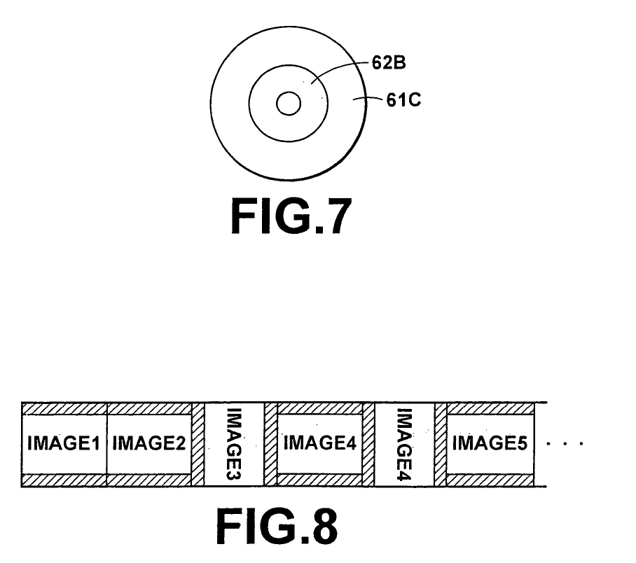

The DVD-R used in this embodiment is not necessarily limited to the dual layer structure DVD-R described above. As shown in FIG. 7, a DVD-R may be used wherein the organic dye layer 61C in the first recording layer is located on the inner periphery side thereof while the phase-change metal layer 62B in the second recording layer 62 is located on the outer periphery side thereof. This structure can be used because a speed of rotation is slower on the inner periphery side than the outer periphery side, which reduces probability of failure of data writing.

In this embodiment, when the DVD-Video files V0 are generated, orientation may not be known regarding some of the images represented by the image data sets S2 to be included in the DVD-Video files V0. In this case, the DVD-Video files V0 are generated in such a manner that the images of unknown orientation are serially reproduced without changing the orientation thereof and in the portrait orientation upon reproduction of the slide shows. FIG. 8 shows how the images of unknown orientation are serially reproduced without a change in orientation and with a change to the portrait orientation. In FIG. 8, an image 4 to be reproduced fourth in the corresponding slide show is reproduced firstly without the orientation change, then with a change to the portrait orientation.

For the images of unknown orientation, the user 2 can confirm which orientation is right through serial reproduction of the images in the original orientation and in the portrait orientation. The user 2 then skips the images whose orientation is not right among the images reproduced serially in the slide shows by using the user terminal 20 or a DVD player having an editing function. By storing information representing the images that have been skipped, the skipped images are not reproduced with reference to the information in reproduction of the DVD-Video files V0 thereafter. Therefore, the slide shows including only the images of right orientation can be reproduced.

In addition to the DVD-Video files V0 generated according to year range, DVD-Video files V0 may be generated from the image data sets S2 including a predetermined keyword in the comment such as an athletics meet or the name of a child of the user 2. For example, a DVD-Video file (hereinafter referred to as a DVD-Video file V1) including “athletics meet” as a keyword in the comment may be generated in addition to the DVD-Video files V0 classified according to year range so that the images of athletics meet in the DVD-Video files V0 are linked to the DVD-Video file V1.

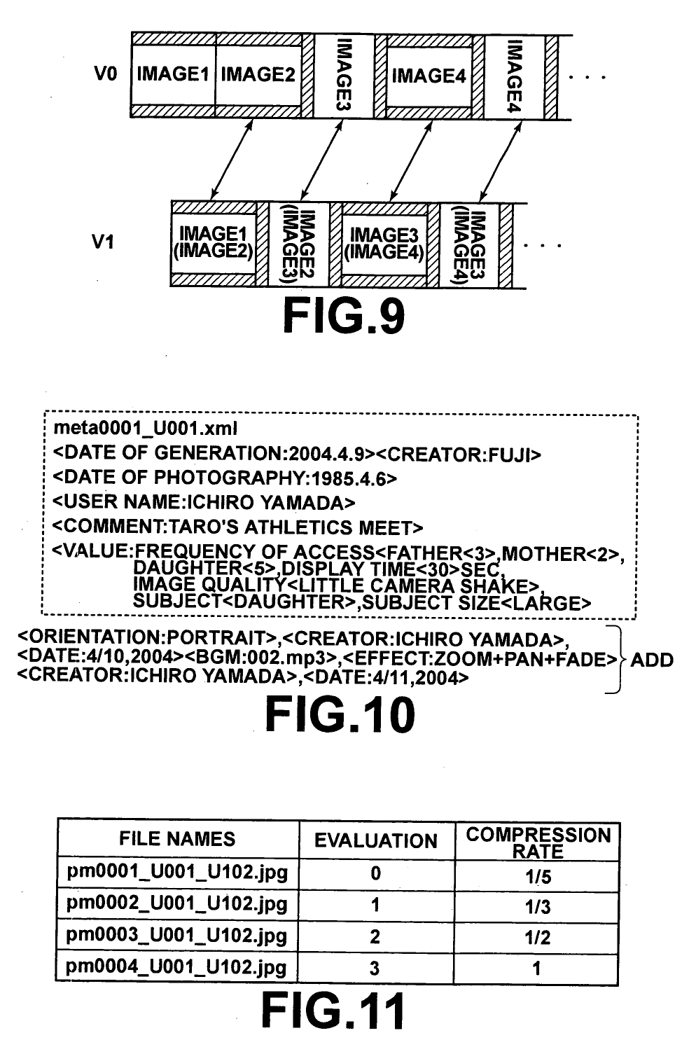

FIG. 9 shows a link between the DVD-Video files. As shown in FIG. 9, assume that the second to fourth images in one of the DVD-Video files V0 have the comment including the keyword “athletics meet” and the first to third images in the DVD-Video file V1 correspond to the second to fourth images in the DVD-Video file V0. In this case, the second to fourth images in the DVD-Video file V0 are linked to the first to third images in the DVD-Video file V1.

In the case where the user 2 carries out operation for moving the link when the second image is being displayed in reproduction of the DVD-Video file V0, the DVD-Video file V1 is reproduced from the first image therein. In this manner, when an image of athletics meet is displayed during reproduction of one of the slide shows, the slide show only including the images of athletics meet can be reproduced thereafter.

The representative images of the image data sets S2 recorded in the DVD-R may be printed on the surface of the DVD-R. In addition, the ID specific to the DVD-R may be printed thereon.

The DVD-R generated in this manner is sent to the user 2. The user 2 can enjoy the slide shows by reproducing the DVD-Video files V0 recorded in the DVD-R. Furthermore, the user 2 can carry out catalog display and editing of the image data sets S2 recorded in the DVD-R on the user terminal 20.

At this time, the user 2 may be provided with a recording medium having information representing a slide show sequence comprising various kinds of images for demonstration and background music so that the user 2 can replace some of image data sets S2 in the DVD-R with the demonstration images in the slide show sequence. In this manner, the user 2 can enjoy the slide shows of the images of his/her own in various manners, by the replacement with the demonstration images.

The user 2 has installed viewer dedicated to the photo mining service in the user terminal 20. The user 2 can use the viewer for changing the orientation of the image data sets S2 in the DVD-R, changing the background music and the effect for reproducing the DVD-Video files V0, and for changing the comment, for example.

When the image data sets S2 are displayed by the viewer, all the meta-data sets X0 recorded in the DVD-R are copied in the user terminal 20. Whenever the image data sets S2 are changed in the above manner, the content of the change is added to the corresponding meta-data sets X0.

FIG. 10 shows how the change is added to the meta-data sets X0. The part surrounded by broken lines represents the original content of one of the meta-data sets X0. In the case where the orientation of the corresponding image data set S2 is wrong and thus changed to the portrait orientation, information “<orientation: portrait>”, information on the name of the creator “<creator: Ichiro Yamada>”, and information on the date of the change “<date: 4/10, 2004>” is added to the meta-data set X0. In the case where the background music and the effect used at the time of reproduction of the DVD-Video file V0 including the image data set S2 are changed, information “<BGM: 002.mp3>” and “<effect: zoom+pan+fade>” is added together with the information on the name of the creator and the date of change “<creator: Hanako Yamada>” and “<date: 4/11, 2004>”.

The name of the creator is the name of the user who carries out the change by logging on to the user terminal 20. However, the name of a person who logs on may be selected at the time of starting the viewer so that the creator name can be the name of the person. At this time, the names of persons who can log on as well as face images thereof may be displayed in a screen for selecting the person.

Whenever the user 2 displays any one of the image data sets S2, information is added to the item “value” in the corresponding meta-data set X0. More specifically, how many times and how long the image data set S2 is displayed by each of the users 2, a quality of the image, the number of subjects in the image, and a desirable size of the subject are added to the meta-data set X0. How many times the image is displayed is counted for each of the users 2 logging on to the terminal 20 to display the image data set S2 or for the person selected at the time of starting the viewer. How long the image is displayed is represented by a total time of display of the image data set S2 for all the users 2. The quality, the number of people, and the desirable size of the subject are input as numbers by any one of the users 2 using the viewer, and added to the meta-data set X0.

In some cases, the user 2 may wish to provide the image data sets S2 recorded in the DVD-R to another person. For example, upon marriage of a son or daughter of the user 2, the user 2 may wish to provide him/her with a part of the image data sets S2 representing images related to him/her. In the case where the user 2 has a plurality of the DVD-R's by repeatedly using the photo mining service, the user 2 may wish to record the image data sets S2 in all the DVD-R's collectively in a DVD-R or may wish to provide his/her son or daughter with the image data sets S2 related to him/her.

In such a case, the user 2 can place an order for generation of a new DVD-R by sending the DVD-R he/she has to the digitalization center 4. In the digitalization center 4, the image generation apparatus 40 reads from the DVD-R the image data sets S2 related to the son or daughter by referring to the comment or the like added to the image data sets S2, and generates images in the form of slide shows from the image data sets S2 that have been read. The image generation apparatus 40 then records the image data sets S2 that have been read and the image data sets as the slide shows in the new DVD-R. In the case where the user 2 has a plurality of the DVD-R's generated by repeated use of the photo mining service, all the DVD-R's are sent to the digitalization center 4 for an order for generation of the new DVD-R.

In the case where the new DVD-R is generated in the digitalization center 4 as has been described above, the user 2 provides the meta-data sets X0 whose content has been added by the viewer to the digitalization center 4, together with the DVD-R. More specifically, the meta-data sets X0 are sent from the user terminal 20 to the digitalization center 4 via the Internet 7, or sent to the digitalization center 4 by being recorded in a recording medium such as a memory card owned by the user 2 or provided to the user 2 as a part of the photo mining service. Alternatively, in the case where the DVD-R is rewritable or has a recording space wherein data can be rewritten, the meta-data sets X0 are recorded therein and sent to the digitalization center 4. The file names of the meta-data sets X0 sent to the digitalization center 4 include the ID specific to the DVD-R. Therefore, the DVD-R is easily related to the meta-data sets X0.

How the new DVD-R is generated will be described below. The new DVD-R is generated by the image generation apparatus 40. In this embodiment, the case will be described where a new DVD-R 102 is generated having the image data sets S2 related to a daughter of the user 2, from two DVD-R's 100 and 101 owned by the user 2.

The DVD generation unit 52 selects the image data sets (hereinafter referred to as image data sets S12) including the comment having the name of the daughter and a word “daughter” from the image data sets S2 recorded in the DVD-R's 100 and 101. The DVD generation unit 52 then finds evaluation of the image data sets S12 with reference to the information on the value described in the corresponding meta-data sets X0 of the image data sets S12. The information on the value represents how many times and how long each of the image data sets S12 is displayed by each of the users 2, as well as the image quality, the type of subject, and the size of the subject.

In this embodiment, the DVD generation unit 52 calculates the evaluation (referred to as Val0) for each of the image data sets S12 according to the function described by Equation (1) below:
V0=ax₁+bx₂+cx₃+dx₄+ex₅+fx₆ (1)
where a through f are weights and x₁ through x₆ are as follows:

x₁: how many times the image is displayed (how many times the image of the daughter is displayed in this case)

x₂: how long the image is displayed

x₃: amount of information of the corresponding meta-data set X0

x₄: the image quality

x₅: the number of people

x₆: the size of the subject.

In Equation (1), the evaluation Val0 becomes larger as x₁ to x₆ become larger. Therefore, the evaluation Val0 reflects preference of the daughter of the user 2 as a target of the DVD-R 102 to be generated newly.

The evaluation Val0 calculated in this manner is added to the meta-data sets X0 of the image data sets S12 with the name of creator “FUJI”. In this embodiment, the evaluation Val0 is written as a number ranging from 0 to 3 according to a range of the value of Val0 that has been calculated.

The image conversion unit 51 then changes the file names of the image data sets S12 by adding an ID specific to the new DVD-R 102 in which the image data sets S12 are written. For example, if the ID specific to the new DVD-R 102 is U102 and the file name of one of the image data sets S12 read from the DVD-R 100 is pm0001_U001.jpg, the file name of the image data set S12 is changed to pm0001_U001_U102.jpg. In the case where the file name of one of the image data sets S12 read from the DVD-R 101 is pm0001_U002.jpg, the file name is changed to pm0001_U002_U102.jpg. Since the image data sets S12 read from the DVD-R's 100 and 101 have the IDs specific thereto, the file names cannot be identical.

The meta-data sets X0 are also generated in relation to the image data sets S12. The meta-data sets X0 are generated by addition of the information on the value, the file names of background music used in newly generated DVD-Video files V0, and an effect used at the time of reproduction of slide shows to the meta-data sets X0 provided by the user 2.

A meta-data set X0 may be recorded in one file regarding the images that have been stored in the same DVD-R. In this case, the meta-data sets X0 have the IDs of two of the discs and the file names of the images in the original respective discs, such as <disc ID; U001>, <disc ID; U102>, <file name; pm0001_U001_U102.jpg> and soon. If the file names are different from each other in the same directory by storing the images from the same disc in the same directory, for example, the disc IDs in the file names may be omitted in such as <disc ID; U001>, <disc ID; U102>, <file name; pm0001.jpg> and so on.

If the meta-data sets X0 describe information on date of writing the image data sets, when the image data sets have been copied from which of the discs can be easily known.

The DVD generation unit 52 records in the new DVD-R 102 all the image data sets S12 whose file names have been changed by the image conversion unit 51 and the meta-data sets X0, by classifying the data sets into folders according to year range. At the same time, the DVD generation unit 52 calculates total free space size in the DVD-R 102 in the case where all the image data sets S12 are recorded therein. The DVD generation unit 52 then generates the DVD-Video files V0 whose size is appropriate for the free space size, and records the DVD-Video files V0 in the DVD-R 102.

In the case where the image data sets S12 regarding the daughter of the user 2 are read from the DVD-R's 100 and 101 and recorded in the DVD-R 102, the total size of the image data sets S12 may exceed the capacity of the DVD-R 102. In this case, the information on the evaluation described in the meta-data sets X0 of the image data sets S12 is referred to, and a compression rate therefor is changed in a stepwise manner according to the evaluation Val0. More specifically, the compression rate is set higher for each of the image data sets S12 of lower value so that the size thereof becomes smaller. The compression rate is set higher for the image data sets S12 of lower value, since quality degradation of the image data sets of lower value does not matter for the user 2.

FIG. 11 shows how the compression rate is changed according to the evaluation. As shown in FIG. 11, in the case where the evaluation Val0 of the image data sets S12 whose file names are pm0001_U001_U102.jpg, pm0002_U001_U102.jpg, pm0003_U001_U102.jpg, and pm0004_U001_U102.jpg varies from 0 to 3, the compression rate therefor is ⅕, ⅓, ½ and 1, respectively.

The image data sets S12 of the lowest value may not be recorded in the DVD-R. In this manner, the total size of the image data sets S12 can be reduced.

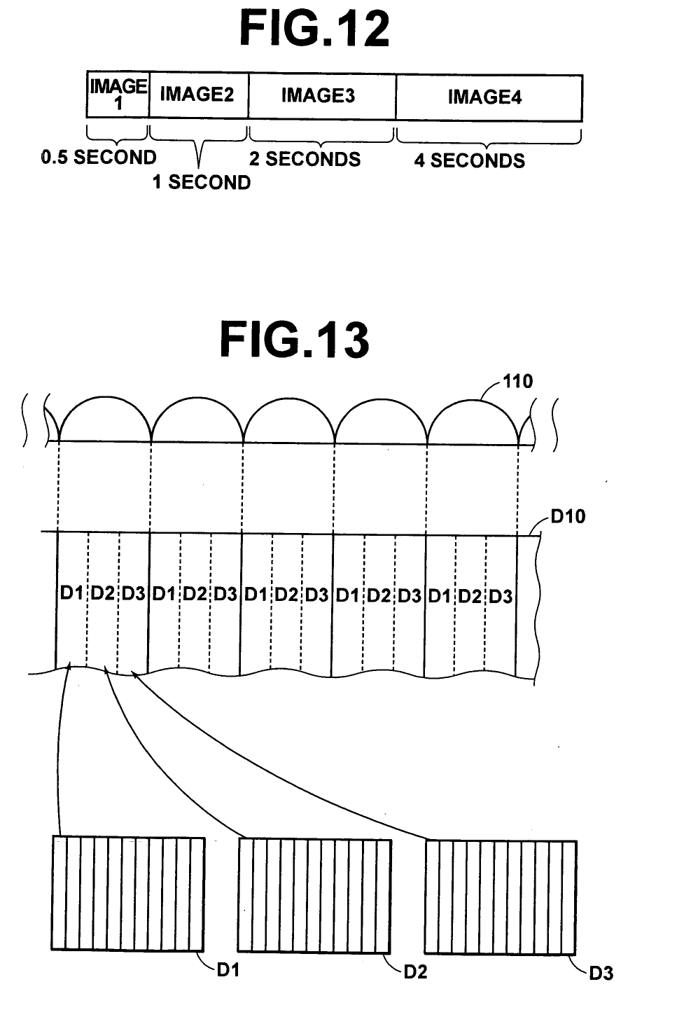

The DVD generation unit 52 generates the DVD-Video files V0 to be recorded in the DVD-R 102 by evenly selecting the image data sets S12 from each of the folders. At this time, the DVD-Video files V0 are generated in such a manner that the image data sets S12 of higher value are reproduced longer, with reference to the information on the evaluation described in the meta-data sets X0 of the selected image data sets S12. For example, since the information on the evaluation ranges from 0 to 3 in this embodiment, the reproduction time is set to be 0.5 second, 1 second, 2 seconds, and 4 seconds as the evaluation increases from 0 to 3. FIG. 12 shows differences in the reproduction time according to the evaluation, in one of the DVD-Video files V0. In FIG. 12, the image data sets S12 whose file names are pm0001_U001_U102.jpg, pm0002_U001_U102.jpg, pm0003₁₃ U001_U102.jpg, and pm0004_U001_U102.jpg are shown as images 1 to 4. The DVD generation unit 52 generates the DVD-Video files V0 so that the image data sets S12 of higher value have longer reproduction time, as shown in FIG. 12.

Representative images of the image data sets S12 may also be printed on the surface of the DVD-R 102. At this time, the representative images are selected according to the information on the evaluation in the meta-data sets X0 of the image data sets S12 so that the image data sets S12 of higher value are selected serially as the representative images. The IDs of the original DVD-R's 100 and 101 and the DVD-R 102 may also be printed on the surface.

In this embodiment, the image data sets S12 read from the DVD-R's 100 and 101 are recorded in the DVD-R 102. However, the representative images of the image data sets S2 may have been printed on the surface of the DVD-R's 100 and 101. In this case, it is preferable for the representative images recorded on the surface of the DVD-R's 100 and 101 to be printed again on the surface of the DVD-R 102 so that the user 2 can understand the DVD-R's from which the DVD-R 102 was generated. However, since the size of the surface of the DVD-R 102 is limited, printing all the representative images of the DVD-R's 100, 101 and 102 on the surface of the DVD-R 102 is difficult.

For this reason, in this embodiment, the representative images of the three DVD-R's are subjected to lenticular image generation processing and printed on the surface of the DVD-R 102. Hereinafter, the lenticular image generation processing will be described. FIG. 13 shows the lenticular image generation processing using three images. In FIG. 13, a lenticular lens sheet 110 is shown in cross section. The case will be described where one of the representative images printed on each of the DVD-R's is used for the lenticular image generation processing. The image data sets S2 representing the representative images of the DVD-R's 100 and 101 and the image data set S12 selected as the representative image of the image data sets S12 from the DVD-R 102 are used for the lenticular image generation.

Representative images D1 and D2 printed on the DVD-R's 100 and 101 and a representative image D3 of the DVD-R 102 are divided into narrow strips each having a width of ⅓ of each lens in a lenticular lens sheet 110. The representative images D1 to D3 are combined so that strips at corresponding positions in the images are included in the width (called lenticular pitch) of lenticular. In this manner, a composite representative image D10 is generated and printed on the surface of the DVD-R 102. The composite representative image D10 is then covered with the lenticular lens sheet 110. In this manner, the representative images are printed on the surface of the DVD-R 102.

By printing the representative images on the surface of the DVD-R 102 in this manner, the representative images of the original DVD-R's 100 and 101 and the DVD-R 102 can be viewed as an angle of view changes by slightly tilting the DVD-R 102. Therefore, the original DVD-R's from which the DVD-R 102 was generated can be understood by viewing the surface of the DVD-R 102.

It is preferable for the representative images D1 to D3 to be selected from the folders classified by year range recorded in the DVD-R's. In this case, it is preferable for the narrow strips obtained by dividing the selected representative images D1 to D3 to be laid out in chronological order at the corresponding positions. In the case where the representative images D1 to D3 are selected from one of the folders, the narrow strips may also be laid out in chronological order at the corresponding positions.

In the case where the DVD-R's have the reproduction description files stored therein, it is preferable for the representative images D1 to D3 to be selected based on the description in the reproduction description files. In this case, the narrow strips obtained by dividing the selected representative images D1 to D3 are preferably laid out in the reproduction order at the corresponding positions.

In the case where the DVD-R's have the Index-Video files Vidx stored therein, it is preferable for frame data sets selected from the frames comprising the Index-Video files Vidx to be selected as the representative images D1 to D3.

In the case where the lenticular image generation processing is carried out, the number of images to be displayed can be increased by arranging narrow strips of other images next to the narrow strips along the longitudinal direction thereof. FIG. 14 shows an example of such a case. In FIG. 14, a composite representative image D11 of representative images D4 and D5 is laid out below in the longitudinal direction of the strips of the composite representative image D10 generated from the representative images D1 to D3 shown in FIG. 13. In this case, it is preferable for the narrow strips obtained by dividing the representative images D1 to D5 to be laid out in chronological order, such as D1, D4, D2, D5, and D3.

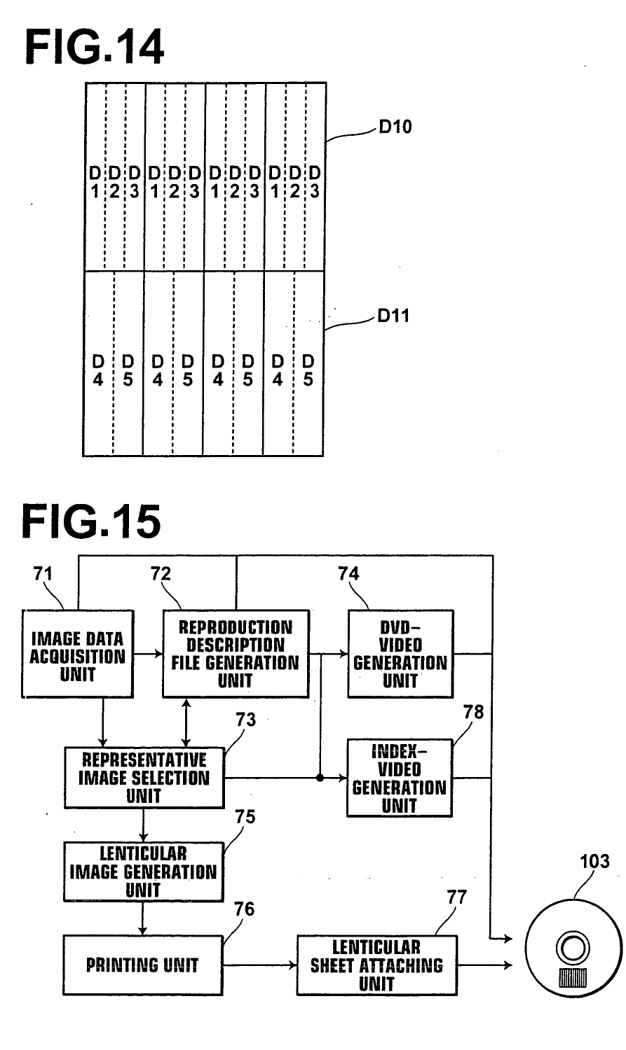

FIG. 15 is a block diagram showing the configuration of the DVD generation unit 52. In this case, a DVD-R 103 is generated. As shown in FIG. 15, the DVD generation unit 52 comprises an image data acquisition unit 71, a reproduction description file generation unit 72 for generating the reproduction description files, a representative image selection unit 73 for selecting the representative images, a DVD-Video generation unit 74 for generating the DVD-Video files V0, a lenticular image generation unit 75 for carrying out lenticular image generation processing on the representative images, a printing unit 76 for printing the composite representative image obtained by the lenticular image generation processing on the lenticular sheet or on the surface of the DVD-R 103, a lenticular sheet attaching unit 77 for attaching the lenticular sheet to the composite representative image, and an Index-Video generation unit 78 for generating the Index-Video files Vidx.

Operation of the DVD generation unit 52 shown in FIG. 15 will be described next. The image data sets obtained by the image data acquisition unit 71 are classified into the predetermined folders, and recorded in the DVD-R 103 together with the meta-data sets. The reproduction description file generation unit 72 selects the images to be included in the DVD-Video files V0, and generates the reproduction description files showing the reproduction order and the reproduction time. The reproduction description file generation unit 72 records the reproduction description files in the DVD-R 103. The DVD-Video generation unit 74 generates the DVD-Video files V0 in the form of the slide shows based on the reproduction description files, and records the DVD-Video files V0 in the DVD-R 103.

Meanwhile, the representative image selection unit 73 selects the representative images, based on the meta-data sets or the like. The Index-Video generation unit 78 generates the Index-Video files Vidx according to the representative images selected by the representative image selection unit 78 and according to the content of the reproduction description files generated by the reproduction description file generation unit 72. The Index-Video generation unit 78 records the Index-Video files Vidx in the DVD-R 103.

The lenticular image generation unit 75 divides the representative images selected by the representative image selection unit 73 into the narrow strips corresponding to the lenticular pitch, and generates the composite representative image by carrying out the lenticular image generation processing thereon according to the chronological or reproduction order.

The printing unit 76 prints the composite representative image generated by the lenticular image generation unit 75 on the lenticular sheet or on the surface of the DVD-R 103. The lenticular sheet attaching unit 77 attaches the lenticular sheet on the surface of the DVD-R 103.

By attaching the composite representative image generated by the lenticular image generation processing to the surface of the DVD-R 103, the slide shows can be previewed in a simplified manner by viewing the surface of the DVD-R 103 in a slight tilt before inserting the DVD-R 103 in a DVD player for reproduction of the slide shows of the images. Therefore, which of the images and the images of which of the periods are recorded as the slide shows in the DVD-R 103 can be easily understood by a glance, which is substantially effective.

In the digitalization center 4, the IDs specific to the DVD-R's provided to the user 2 may be managed for the user 2. In this case, which of the DVD-R's stores the image data sets from which of the DVD-R's can be managed by the ID specific to each of the DVD-R's. In this manner, even in the case where the user 2 has lost anyone of the DVD-R's, which of the DVD-R's of which user was read for recording the image data sets in the lost DVD-R can be understood by notification of the ID specific to the lost DVD-R to the digitalization center 4, as long as the ID is known. Therefore, in the case where the lost DVD-R has been generated by reading the image data sets stored in other DVD-R's, the lost DVD-R can be generated again by asking the user 2 having the original DVD-R's to send the DVD-R's to the digitalization center 4 or by asking the user 2 to send the image data sets recorded in the original DVD-R's, unless the lost DVD-R was generated as the original.

The user 2 may notify the loss of the DVD-R to the digitalization center 4. In this case, whenever an order is placed from the digitalization center 4 for generation of a new DVD-R using the original DVD-R's storing the image data sets recorded in the lost DVD-R, the image data sets in the original DVD-R's may be stored in the digitalization center 4. At the time all the image data sets recorded in the original DVD-R's are stored, a new DVD-R storing the image data sets can be generated. The newly generated DVD-R has the same image data sets recorded in the lost DVD-R. Therefore, the same DVD-R as the lost DVD-R may be generated in the digitalization center 4 by notification of the loss to the digitalization center 4, although this manner is time-consuming.

When a new DVD-R is generated, the image data sets recorded in the original DVD-R's but not used for generation of the new DVD-R may be encoded. Alternatively, an invisible property for causing the image data sets to become invisible may be set on the image data sets and stored in the new DVD-R. In this case, information thereon is managed by the digitalization center 4.

A DVD has large capacity, and a DVD having much larger capacity than a currently available DVD, such as Blu-ray disc, may generally become available. Therefore, by appropriately changing the compression rate of the image data sets according to the information on the evaluation, the image data sets recorded in the original DVD-R's but not used for generation of a new DVD-R may be encoded or recorded in a new DVD-R by being added with the invisible property.

In this manner, even if the user 2 lost the DVD-R, the image data sets recorded in the DVD-R are all stored in other DVD-R's. Therefore, the lost DVD-R can be generated again by obtaining the DVD-R's and decoding or visualizing the image data sets in the digitalization center 4.

In the embodiment described above, the user 2 can request generation of the DVD-Video files V0 from a DPE store by using a terminal in the store and the image data sets recorded in the DVD-R's. At this time, if the terminal in the store is connected to a music storage server storing music data in relation to an ID thereof, the user 2 may obtain in advance the ID of the music data corresponding to background music to be included in slide shows by selecting the background music with the user terminal 20 or a mobile phone. In this case, the music data having the ID can be downloaded through access to the music storage server from the terminal by input of the ID at the time of generation of the DVD-Video files V0. In this manner, the DVD-Video files V0 can be generated by using the music data having the ID.

1. A recording medium for recording various kinds of information including image data,
the recording medium having a first recording area and a second recording area, and the first recording area having higher durability than the second recording area.

2. The recording medium according to claim 1, wherein the first recording area is not rewritable while the second recording area is rewritable.

3. The recording medium according to claim 1, wherein the recording medium forms a dual layer structure and the layer on the topside is the second recording area when viewed from a reading unit.

4. The recording medium according to claim 1, wherein the recording medium is shaped into a disc and the first recording area is located on the inner peripheral side thereof while the second recording area is located on the outer peripheral side thereof.

5. The recording medium according to claim 1, wherein the recording medium has still image data sets recorded in the first recording area, image data recorded in the second recording area in the form of a slide show for reproducing the still image data sets in predetermined order, and meta-data recorded in the first recording area and the second recording area for describing a manner of reproduction of the slide show.

6. The recording medium according to claim 1, wherein the recording medium is an optical recording medium.

7. The recording medium according to claim 1, wherein the recording medium is a DVD.

8. An image recording apparatus comprising recording means for recording still image data sets, image data, and meta-data in a recording medium comprising a first recording area and a second recording area, the first recording area having higher durability than the second recording area, the recording means recording the still image data sets in the first recording area and recording the image data in the second recording area in the form of a slide show for reproducing the still image data sets in predetermined order, and the recording means recording the meta-data describing a manner of reproduction of the slide show in the first recording area and in the second recording area.

9. The image recording apparatus according to claim 8, wherein the first recording area is not rewritable while the second recording area is rewritable.

10. The image recording apparatus according to claim 8, wherein the recording medium forms a dual layer structure and the layer on the topside is the second recording area when viewed from a reading unit.

11. The image recording apparatus according to claim 8, wherein the recording medium is shaped into a disc, and the first recording area is located on the inner peripheral side thereof while the second recording area is located on the outer peripheral side thereof.

12. An image recording method comprising the steps of:
recording still image data sets in a first recording area in a recording medium comprising the first recording area and a second recording area, the first recording area having higher durability than the second recording area;
recording image data in the second recording area in the form of a slide show for reproducing the still image data sets in predetermined order; and
recording meta-data describing a manner of reproduction of the slide show in the first recording area and in the second recording area.

13. A program for causing a computer to execute an image recording method comprising the steps of:
recording still image data sets in a first recording area in a recording medium comprising the first recording area and a second recording area, the first recording area having higher durability than the second recording area;
recording image data in the second recording area in the form of a slide show for reproducing the still image data sets in predetermined order; and
recording meta-data describing a manner of reproduction of the slide show in the first recording area and in the second recording area.
